(19) United States
(12) Patent Application Publication
(10) Pub. No.: US 2003/0033391 A1
(43) Pub. Date: Feb. 13, 2003

(54) Computer processing of audiovisual data

(75) Inventors: Valere Picoureix, Malakoff (FR); Marc Radermacher, Dardilly (FR); Regis Vidal, Estrablin (FR); Fabien Hure, Nemours (FR)

Correspondence Address: SCHNADER HARRISON SEGAL & LEWIS, LLP, 1600 MARKET STREET, SUITE 3600, PHILADELPHIA, PA, 19103

(73) Assignee: Mondial Communications Systems, S.A., Paris (FR)

(21) Appl. No.: 10/191,603

(22) Filed: Jul. 9, 2002

(30) Foreign Application Priority Data
Jul. 10, 2001 (FR) 01/09171

(51) Int. Cl. G06F 15/177

(52) U.S. Cl. 709/220

(57) ABSTRACT

A method of processing multimedia data for creating a digital audiovisual application including recording in resident memory 1) a library of families of computer-based objects corresponding to elementary audiovisual functionalities associated with descriptors, each family comprising at least one object and an interpreter and 2) at least one object transformer comprising a digital file comprising routines for modifications of audiovisual characteristics of an object, constructing a temporary table of instructions recorded in random access memory during the execution of the interpretation in process, the operation consisting of pointing to at least one of the families, verifying compatibility of the family with the interpreter and, in affirmative cases, recording in the table descriptors of objects of the family, and verifying between an object transformer and objects previously recorded in a temporary table and, in affirmative cases, applying a corresponding modification to compatible objects.

### RELATED APPLICATION This application claims priority of French Patent No. FR 01/09171, which was filed on Jul. 10, 2001.

### FIELD OF THE INVENTION

The present invention concerns the field of computer processing of audiovisual data.

### BACKGROUND

Known in the state of the art is European patent EP 643,349 which describes a procedure for the execution of a particular proxy operation called up by a client in a computer system so as to reduce the amount of memory space required by the proxies of the client side, characterized by the following steps:

access from a first zone of the computer memory to a first part of code required to execute said proxy operation by calling up a proxy interpreter to execute said proxy operation, said proxy interpreter supplying said first part of code whenever said proxy operation is called up, said first part of code being identified as common to a multiplicity of different proxy operations;

access from a second zone of the computer memory to a second part of the code required to execute said proxy operation, said second part of code being identified as unique for said particular proxy operation and said second part of code being stored in a compressed format; and

execution of said proxy operation at the moment of execution by interpretation of said first and second parts of code without explicit C++ code for a procedure, an argument and an exception of said proxy operation.

### SUMMARY OF THE INVENTION

This invention relates to a method of processing multimedia data for creating a digital audiovisual application including recording in resident memory 1) a library of families of computer-based objects corresponding to elementary audiovisual functionalities associated with descriptors, each family comprising at least one object and an interpreter and 2) at least one object transformer comprising a digital file comprising routines for modifications of audiovisual characteristics of an object, constructing a temporary table of instructions recorded in random access memory during the execution of the interpretation in process, the operation consisting of pointing to at least one of the families, verifying compatibility of the family with the interpreter and, in affirmative cases, recording in the table descriptors of objects of the family, and verifying between an object transformer and objects previously recorded in a temporary table and, in affirmative cases, applying a corresponding modification to compatible objects.

### BRIEF DESCRIPTION OF THE DRAWINGS

Enhanced understanding of the present invention will be obtained from the description below with reference to the attached drawings pertaining to a nonlimitative example of implementation in which:

FIG. 1 represents the diagram of a part of the interpreter initialization procedure for the implementation of the invention,

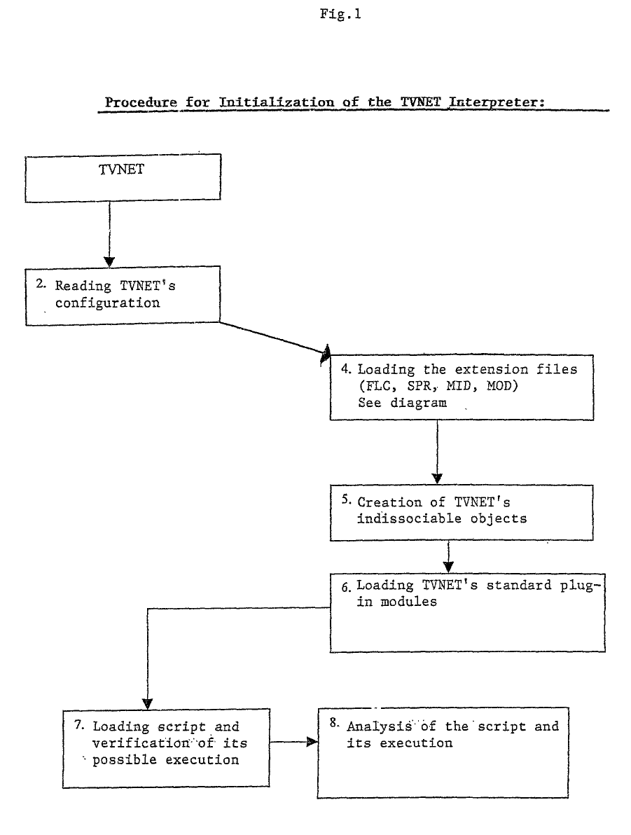

FIG. 2 represents a schematic view of the structure of the modifiers, and

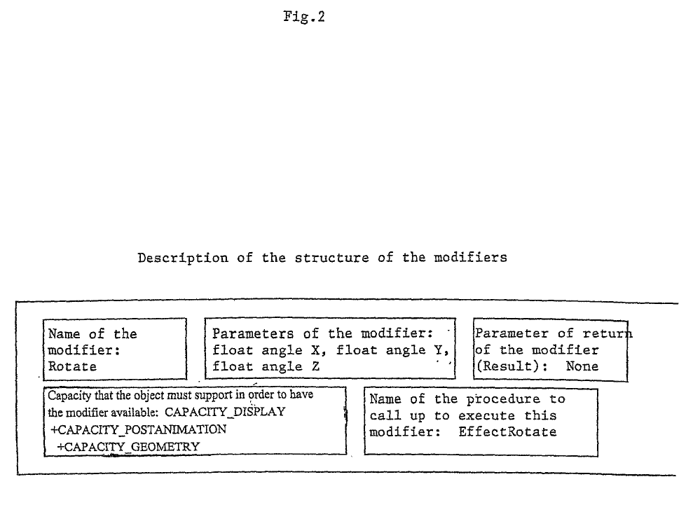

FIG. 3 represents a schematic representation of the analysis of a script and the loading of families of nonstandard objects.

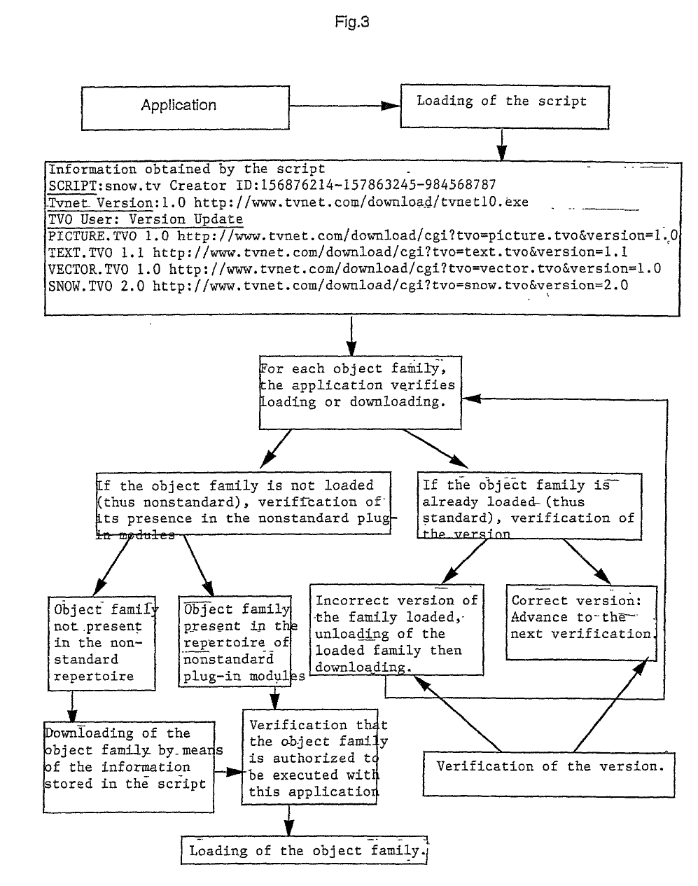

### DETAILED DESCRIPTION

The invention provides a procedure for processing audiovisual data enabling the processing of computer files according to a specific language optimized for such applications.

In its broadest sense, the invention concerns a procedure for processing multimedia data for the creation of an interactive digital audiovisual application comprising:

a first step of recording in resident memory a library of families of computer-based objects corresponding to elementary audiovisual functionalities (display an image, play a sound, etc.) associated with descriptors, each family comprising at least one object as well as an interpreter,

a dynamic step of constructing a temporary table of instructions recorded in random access memory during the execution of the interpretation in process, said operation consisting of pointing to at least one of said families, verifying the compatibility of said family with said interpreter and, in the affirmative case, of recording in said table the descriptors of the objects of said family,

characterized in that the first step furthermore consists of recording in said database at least one object transformer (a digital file comprising routines for modifications of the audiovisual characteristics of an object),

the construction step comprising an operation of verification of the compatibility between an object transformer and the objects previously recorded in said temporary table and, in the affirmative case, of applying the corresponding modification to said compatible objects.

The dynamic step of constructing the temporary instruction table advantageously consists of recording in said table the totality of the computer-based objects and the database transformers from the resident memory.

According to a variant, the dynamic step of constructing the temporary instruction table is executed upon each receipt of an execution file comprising a control block and at least one object identifier and, if required, at least one object transformer, the process consisting of loading in the table the objects and object transformers corresponding to said identifiers.

The dynamic step of constructing the instruction table preferably furthermore consists in an operation of deletion from the table of the objects and transformers previously recorded in said table, the identifiers of which are not contained in said execution file.

According to another variant, the verification of compatibility consists of comparing the identifier of a descriptor of the contained interpreter of the object family or transformer and the descriptor of the interpreter currently in use and of authorizing recording in the table when the interpreter detects a valid identifier.

According to one particular mode of implementation, the verification of compatibility consists of comparing the identifier of a descriptor of an object family or a transformer and the content of the interpreter currently in use, and of authorizing recording in the table when the interpreter detects a valid family or transformer identifier.

According to another mode of implementation, the verification of compatibility comprises a step of verification between a capacity identifier contained in an object and the capacity identifier of a transformer “capacity to be displayed”, “capacity to be moved onto the screen”, “capacity to be moved in time” and to advance to the addition of information in the instruction table concerning the object by the transformer in the case of positive verification.

The verification of the compatibility of the execution file advantageously consists of verifying whether the identifiers of the objects and transformers appearing in said execution file are contained in the table loaded in random access memory or whether they are recorded in the library in resident memory.

According to a particular mode of implementation, the process according to the invention comprises a file verification step consisting of determining whether the execution file comprises a valid key.

According to a particular variant, it comprises a step of verification of the validity of the interpreter consisting of determining if the execution file comprises a key compatible with the content of the execution file.

The description below presents a nonlimitative example of implementation of the invention.

The invention is manifested by a computer-based application containing an interpreter dedicated to the exploitation of a new language for the description of audiovisual data.

This application implements the steps of processing the computer-based files:

Reading the application configuration file

Loading the executable elements that could call up the instructions for decoding a data flow (for example, decoding audiovisual formats)

Creation of indissociable objects

Loading in random access memory of the families of standard objects

Loading of the input file or script

Analysis of the input files according to said language

Retrieval in a library of the families of nonstandard objects necessary for the restoration of the audiovisual data

Loading in random access memory of the families of nonstandard objects necessary for the restoration of the audiovisual data

The object library is sorted by family and contains different object families.

These objects each comprise a predefined part:

its name

the capacity to accept modifiers. These modifiers express either the properties of the objects or actions, and comprise parameters of the instructions that can stem from the association of an object and a modifier.

They optionally comprise a variable part which is parameterizable for communication with other objects or computer resources.

As an example, sound objects comprise a variable part for detection of the presence of a sound card. In the absence of a sound card, this object would not be loaded by the application.

The process according to the invention enables instantaneous creation of the instructions of a computer-based language.

It thus makes possible the updating, including remote updating, of the language interpreter program without it being necessary to relaunch the executable file.

This process enables optimization of the hardware resources employed and especially of RAM since the instructions are not created until the moment when they are necessary.

This process enables creation of new instructions pertaining to existing objects without it being necessary to modify the code of the module(s) concerning these objects.

The computer program according to the invention is a modular program composed of an executable program and a set of modules called object families.

Description of the process:

When the application is executed it retrieves all of the object families present and, for each family found, verifies whether it is authorized (double key system) to operate with the application (or with the version of the application concerned).

If the object family is not authorized, it is ignored.

The authorized object families are loaded into the random access memory of the system and communicate to the application according to the invention:

The object(s) that they contain.

The “private modifiers” (specific to an object).

The “behavioral modifiers” (common to a category of objects).

Thus the private modifiers will be associated in real time, and only if necessary (prompting by a script), with the objects that have the capacity to accept them.

Not only does this make it possible to construct only the instructions required for a given application and thus to optimize to the maximum the use of the hardware resources, but it also makes possible the enrichment of the system by creation of new instructions stemming from the encounter between a behavioral modifier created for an object and the other objects of the same category.

Upon creation of a modifier, the developer must decide if it is a specific modifier or a behavioral modifier. In the latter case, he must define the category of objects to which this behavior could apply (see attached diagram).

Creation of an application instruction according to the invention

The application associates in a first step each loaded object with possible private modifiers. Each association gives rise to an instruction.

The application then tries to associate the set of behavioral modifiers with the set of objects present by comparing the capacities of each behavioral modifier. Only those instructions are created which associate an object and a behavioral modifier with compatible capacities.

Creation of the family of indissociable objects

The application according to the invention comprises omnipresent, indissociable objects necessary for correct operations.

Loading the families of standard objects

After having loaded the indissociable objects, the application according to the invention loads the families of standard objects, i.e., those that are used most often. The families of nonstandard objects will only be loaded if they are required, i.e., after analysis of the script.

Analysis of the script

The application according to the invention now loads the script (i.e., a sequential list of instructions) which advance in the line of control. There is a succession of steps and verifications prior to the compilation and execution of the script.

First step:

The application loads the script and validates its capacity to be executed. For example:

Version of the application used to create the script.

Listing of all of the families of objects used in the script. The following are indicated for each family of objects: its name, the version used, the identifier of the family (series number if multiple families have the same name) and Internet address for downloading the family(ies) necessary for execution of the script or for updating a family.

Identifier number of the script's author.

Second stage:

The application collects all of this information and compares it with the data present. It verifies whether the version of the application is correct. If it is not, it will download the latest version of the application. Once the new version is installed, the application will start over again at the beginning of the initialization procedure.

The application then verifies one by one each family of objects used by the script and verifies that the version present on the machine is correct. If the version of the family of objects is not correct, the application will download the correct version and update the system.

The application verifies that each family of objects is authorized to function with the current script (verification protocol).

Once all of these steps have been implemented, the script is executed. Then all of the nonstandard families are unloaded.

In the claims

12. (New) A method of processing multimedia data for creating a digital audiovisual application comprising:
recording in resident memory 1) a library of families of computer-based objects corresponding to elementary audiovisual functionalities associated with descriptors, each family comprising at least one object and an interpreter and 2) at least one object transformer comprising a digital file comprising routines for modifications of audiovisual characteristics of an object;
constructing a temporary table of instructions recorded in random access memory during the execution of the interpretation in process, said operation consisting of pointing to at least one of said families, verifying compatibility of said family with said interpreter and, in affirmative cases, recording in said table descriptors of objects of said family; and
verifying between an object transformer and objects previously recorded in a temporary table and, in affirmative cases, applying a corresponding modification to compatible objects.

13. (New) The method according to claim 12, wherein constructing the temporary instruction table comprises recording in said table the totality of computer-based objects and database transformers from the database.

14. (New) The method according to claim 12, wherein constructing the temporary instruction table is executed upon each receipt of an execution file comprising a control block and at least one object identifier and, if required, at least one object transformer, and loading in the table objects and object transformers corresponding to said identifiers.

15. (New) The method according to claim 14, wherein constructing the instruction table further comprises deleting from the table objects and transformers previously recorded in said table, the identifiers of which are not contained in said execution file.

16. (New) The method according to claim 12, wherein verifying compatibility comprises comparing the identifier of a descriptor of the interpreter contained in the object family or transformer and the descriptor of the interpreter currently in use and of authorizing recording in the table when the interpreter detects a valid identifier.

17. (New) The method according to claim 12, wherein verifying compatibility comprises comparing the identifier of a descriptor of an object family or a transformer and the content of the interpreter currently in use, and of authorizing recording in the table when the interpreter detects a valid family or transformer identifier.

18. (New) The method according to claim 12, wherein verifying compatibility comprises verifying between a capacity identifier contained in an object and the capacity identifier of a transformer and, in cases of positive verification, to advance to the addition of information in the instruction table associating the object and the transformer.

19. (New) The method according to claim 14, wherein verifying compatibility of the execution file comprises verifying whether identifiers of the objects and transformers appearing in said execution file are contained in the temporary table loaded in the random access memory or whether they are recorded in the library in the resident memory.

20. (New) The method according to claim 12, further comprising loading from a server missing object families into the temporary table.

21. (New) The method according to claim 19, further comprising a file verification step comprising determining whether the execution file comprises a valid key.

22. (New) The method according to claim 19, further comprising verifying the validity of the interpreter including determining if the execution file comprises a key compatible with content of the execution file.
